(19) United States
(12) Patent Application Publication
(10) Pub. No.: US 2026/0220549 A1
(43) Pub. Date: Jul. 30, 2026

(54) SYSTEMS AND METHODS FOR PRIVACY PRESERVATION WHEN TRAINING DEEP LEARNING MODELS

(71) Applicant: Verizon Patent and Licensing Inc., Basking Ridge, NJ (US)

(72) Inventors: Tommaso BIANCONCINI, Florence (IT); Andrea BENERICETTI, Prato (IT); Douglas COIMBRA DE ANDRADE, Conselheiro Lafaiete (BR); Lorenzo CASELLI, Florence (IT); Simone MAGISTRI, Florence (IT); Andrew David BAGDANOV, Firenze (IT)

(73) Assignee: Verizon Patent and Licensing Inc., Basking Ridge, NJ (US)

(21) Appl. No.: 19/040,185

(22) Filed: Jan. 29, 2025

(51) Int. Cl. G06N 20/20

(52) U.S. Cl. CPC G06N 20/20

(57) ABSTRACT

A device may train a first model with a first dataset to generate a first set of weights, and may delete a portion of the first dataset to generate a modified first dataset. The device may receive a second dataset, and may generate a second model with the first set of weights. The device may fine-tune the second model with the second dataset and to generate a second set of weights, and may generate a knowledge distillation loss by comparing outputs of the first model and the second model based on the modified first dataset. The device may combine the knowledge distillation loss and a classification loss of the second model to generate a combined loss, and may train the second model with the combined loss. The device may perform one or more actions based on the trained second model and the second set of weights.

### BACKGROUND

Machine learning models may be trained on extensive data in order to generate robust and reliable machine learning models. For example, machine learning models may process video data of road scenes to identify instances of distracted driving, traffic violations, or driver fatigue, which may be utilized to improve road safety and driver behavior.

### BRIEF DESCRIPTION OF THE DRAWINGS

FIGS. 1A-1H are diagrams of an example associated with privacy preservation when training deep learning models.

FIGS. 2A and 2B are diagrams illustrating examples of training and using machine learning models.

FIG. 3 is a diagram of an example environment in which systems and/or methods described herein may be implemented.

FIG. 4 is a diagram of example components of one or more devices of FIG. 3.

FIG. 5 is a flowchart of an example process for providing privacy preservation when training deep learning models.

### DETAILED DESCRIPTION OF EXAMPLE EMBODIMENTS

The following detailed description of example implementations refers to the accompanying drawings. The same reference numbers in different drawings may identify the same or similar elements.

Training and improving machine learning models face substantial challenges due to the dynamic natures of domains in which the models operate. Over time, characteristics of data on which the machine learning models are trained inevitably change. For example, new vehicle models may appear on roads, or there could be significant changes in urban landscapes. To keep machine learning models relevant and accurate, the machine learning models may undergo iterative retraining or fine-tuning with a new distribution of data. However, retraining machine learning models may be complicated by privacy regulations that empower customers to request deletion of sensitive data, which must then be removed from the training datasets. Consequently, this may degrade performances of machine learning models. Additionally, incremental learning strategies employed for training models (e.g., deep neural network (DNN) models) using customer data are at odds with privacy requirements. Training on solely new data may lead to suboptimal models.

Thus, current techniques for training models consume computing resources (e.g., processing resources, memory resources, communication resources, and/or the like), networking resources, and/or other resources and fail to handle deletion of data for training a model, failing to train a model with new data. A retrained model may be considerably worse when using new data (after deletion). This results in problems, such as changing characteristics, degrading performance of a model due to no longer having access to the deleted data, failing to employ incremental learning techniques for a model, and/or the like.

Some implementations described herein provide a video system that provides privacy preservation when training deep learning models. For example, the video system may train a first model with a first dataset to generate a first set of weights, and may receive a request to delete a portion of the first dataset. The device may delete the portion of the first dataset based on the request and to generate a modified first dataset, and may receive a second dataset containing new data. The device may generate a second model with the first set of weights from the first model, and may fine-tune the second model with the second dataset and to generate a second set of weights for the second model. The device may utilize knowledge distillation to generate a knowledge distillation loss by comparing outputs of the first model and the second model based on the modified first dataset, and may combine the knowledge distillation loss and a classification loss of the second model to generate a combined loss. The device may train the second model with the combined loss to generate a trained second model, and may perform one or more actions based on the trained second model and the second set of weights.

In this way, the video system provides privacy preservation when training deep learning models. For example, the video system may preserve an accuracy and a robustness of a model after data deletions necessitated by privacy regulations. The video system may utilize knowledge to retain and transfer knowledge from previous model iterations to new models, and may minimize degradation of model performance due to removal of training data. The video system prevents catastrophic forgetting by a model based on implementing measures that ensure a stability of a learned representation over successive learning cycles. The video system may also prevent wasteful retraining of models from scratch. Thus, the video system may conserve computing resources, networking resources, and/or other resources that would have otherwise been consumed by failing to handle deletion of data for training a model, failing to train a model with new data that includes changing characteristics, degrading performance of a model based on deleting data used to train the model, failing to employ incremental learning techniques for a model, and/or the like.

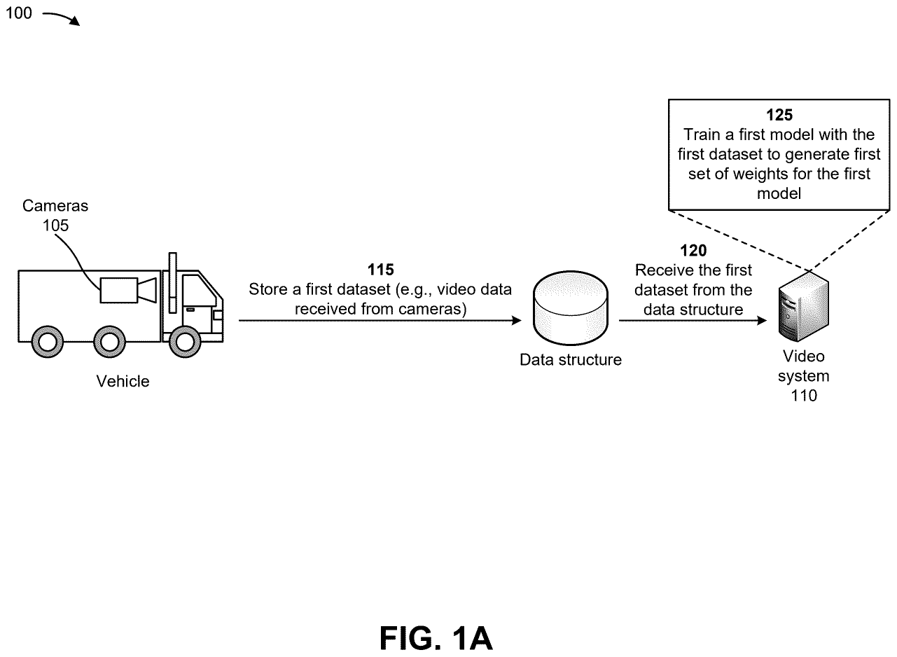

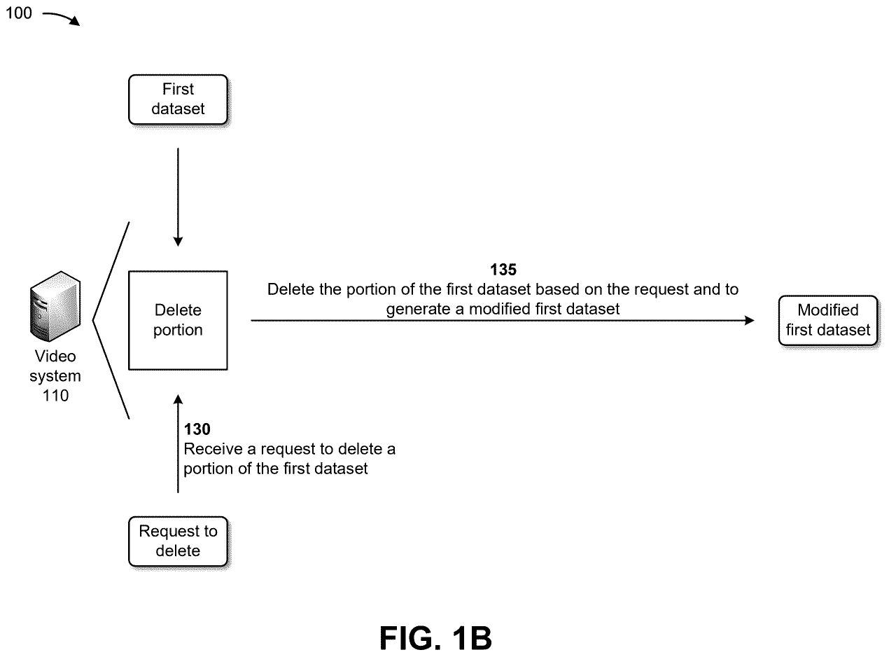

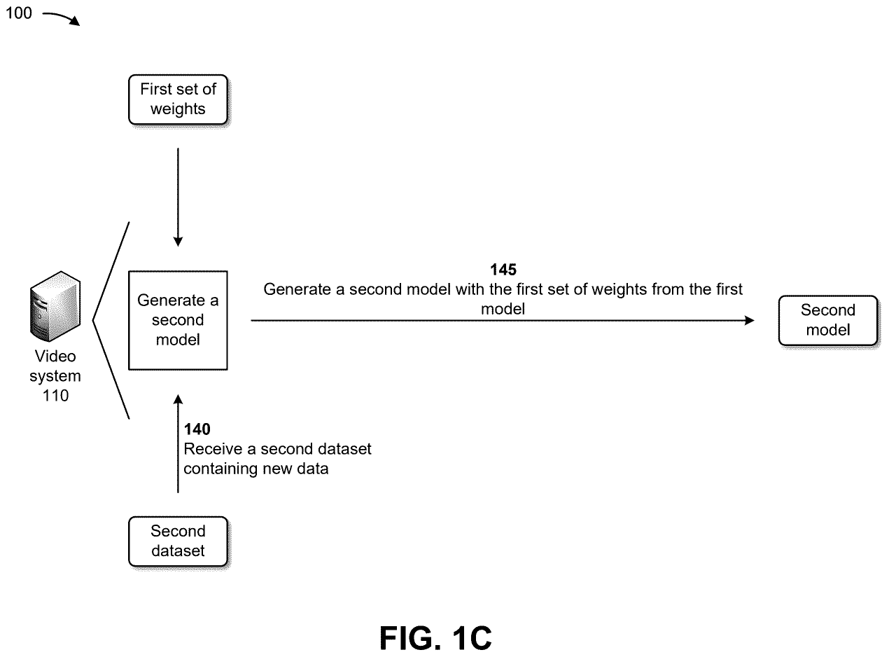

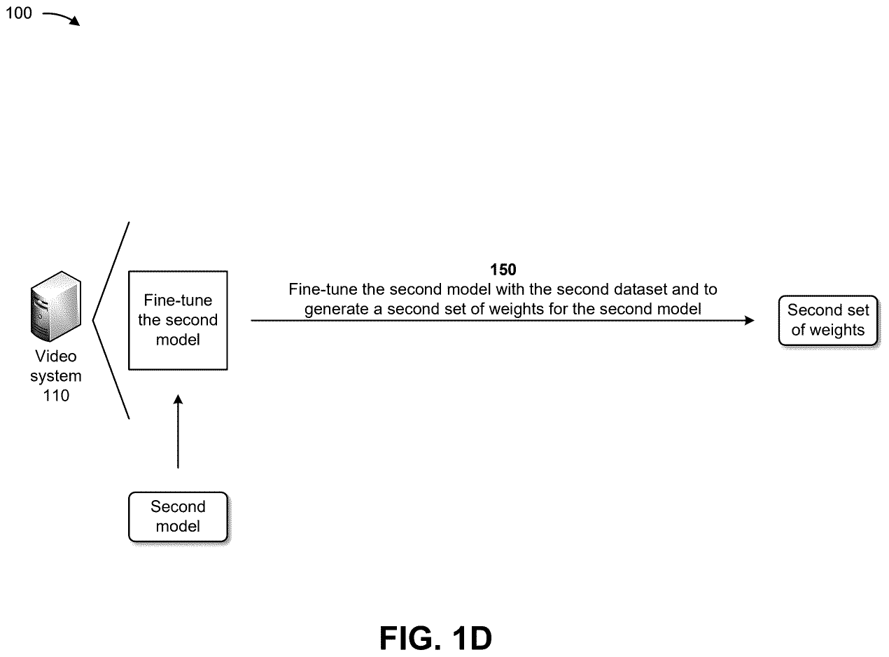

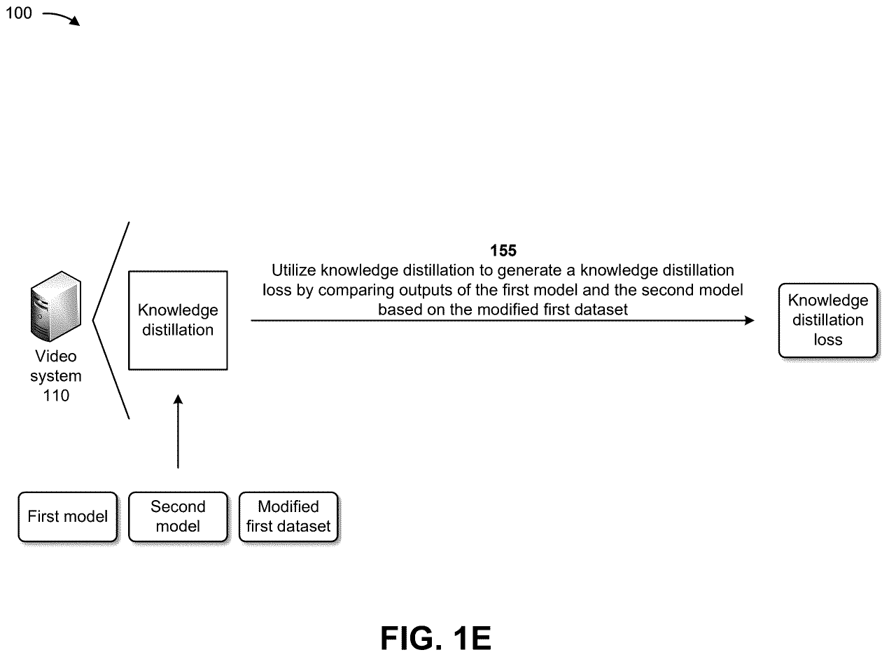

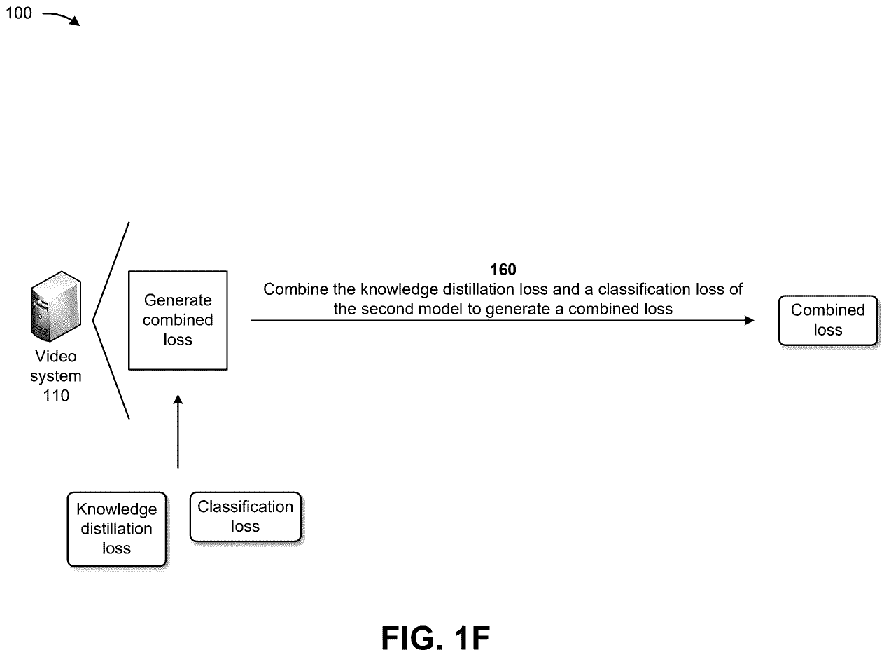

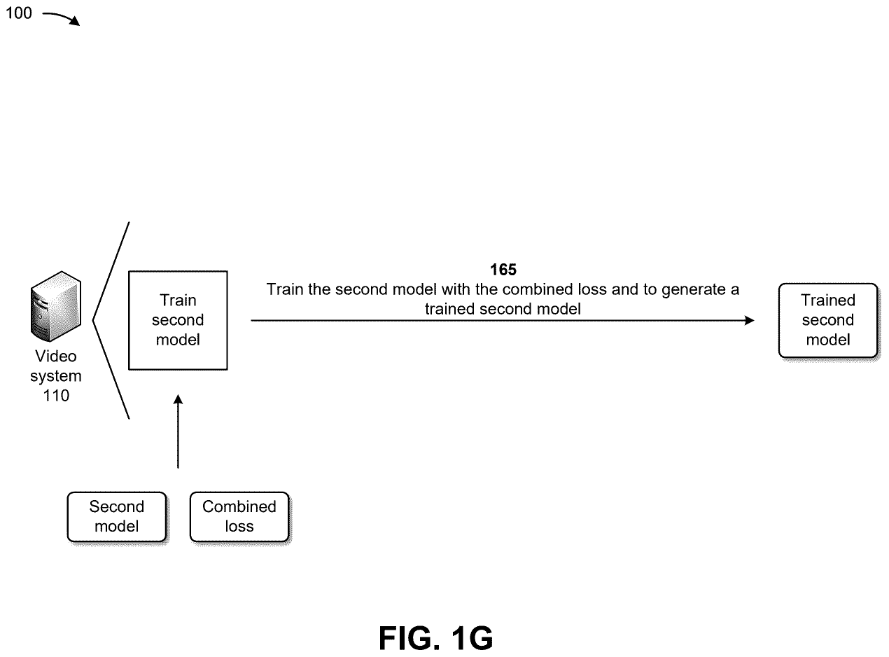

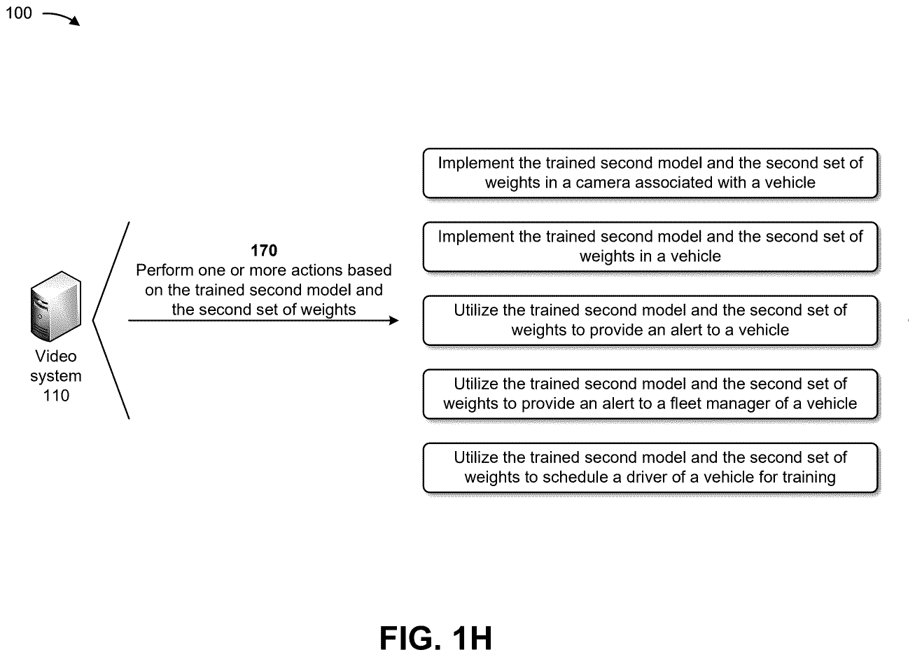

FIGS. 1A-1H are diagrams of an example 100 associated with privacy preservation when training deep learning models. As shown in FIGS. 1A-1H, the example 100 includes cameras 105 and a data structure associated with a vehicle and a video system 110. The cameras 105 may capture video of objects (e.g., packages, cargo, pedestrians, traffic signs, traffic signals, road markers, a driver, animals, and/or the like) associated with the vehicle. Each of the cameras 105 may include a dashcam of the vehicle, a forward-facing camera of the vehicle, a driver-facing camera of the vehicle, a side camera of the vehicle, a rear camera of the vehicle, and/or the like. The data structure may include a database, a table, a list, and/or the like that stores data. The video system 110 may include a system that provides privacy preservation when training deep learning models. Further details of the cameras 105, the data structure, the vehicle, and the video system 110 are provided elsewhere herein. Although implementations described herein depict a single vehicle and a single camera 105, in some implementations, the video system 110 may be associated with multiple vehicles and multiple cameras 105. Furthermore, although implementations depict video data and models for processing video data, the implementations may be utilized with any type of data that may be processed by models.

As shown by FIG. 1A, and by reference number 115, the cameras 105 may store a first dataset (e.g., video data received from the cameras 105) in the data structure. For example, the cameras 105 associated with the vehicle may continuously capture the video data. The cameras 105 may provide the video data to the data structure (e.g., a table, a list, a database, and/or the like), and the data structure may store the video data as the first dataset. In some implementations, the cameras 105 may periodically store the video data in the data structure, may continuously store the video data in the data structure, may store the video data in the data structure based on a request, and/or the like. In some implementations, the video data may include road scenes captured by the cameras 105, driving events associated with the vehicle, driver and the in-cabin events associated with a driver of the vehicle, and/or the like. In some implementations the video data captured by the camera 105 may be annotated in a supervised way by a human reviewer or in an unsupervised way by a third party model.

As further shown in FIG. 1A, and by reference number 120, the video system 110 may receive the first dataset from the data structure. For example, the video system 110 may continuously receive the first dataset from the data structure, may periodically receive the first dataset from the data structure, may receive the first dataset from the data structure based on requesting the first dataset, and/or the like. In some implementations, the video system 110 may continuously (e.g., in near-real-time) receive the first dataset directly from the cameras 105, may periodically receive the first dataset from the cameras 105, and/or the like.

As further shown in FIG. 1A, and by reference number 125, the video system 110 may train a first model with the first dataset to generate first set of weights for the first model. For example, the video system 110 may be associated with one or more machine learning models and may utilize a continual learning framework. In the continual learning framework, the video system 110 may utilize tasks that include new classes (e.g., class-incremental) or new domains for already-known classes (e.g., domain-incremental) to train a model. The video system 110 may utilize a general continual learning framework in which new data arrives (e.g., incremental) and some current data may disappear due to privacy concerns (e.g., decremental).

In some implementations, the video system 110 may train a first model on the first dataset Dₖ which is populated incrementally by adding a series of data sources S₁, . . . , Sₖ. Each data source Sₖ may be a tuple Sₖ=(Xₖ, Zₖ, Yₖ), where Xₖ denotes the input video samples at time step k, Yₖ denotes the corresponding categories from a fixed label space Y, and Zₖ are latent subcategories from a subcategory space Z that changes over time. These latent subcategories may provide a finer representation of categories by capturing more specific behaviors.

Multiple data sources, grouped in the first dataset, may be fed to the first model and these data sources may include overlapping subcategories (e.g., Zᵢ∩Zᵢ≠Ø). Data can be removed from the first dataset due to a removal policy (e.g., based on privacy regulations associated with customers). Consequently, when the first model is retrained with new data, only a subset of the first dataset may still be available. For example, the data available in the first dataset at step k may be denoted as:

$${D}_{1} = {S}_{1} \qquad ( 1 )$$

$${D}_{k} = {S}_{k} ⋃ π ( {D}_{k - 1} ) = {S}_{k} ⋃ ( {D}_{k - 1} ∖ {U}_{k - 1} ) \qquad ( 2 )$$

where π is the removal policy that leads to the removal of the subset of samples Uₖ₋₁⊆Dₖ₋₁ from the previous dataset. This framework may provide the flexibility to regulate different types of data fluctuation scenarios and may simulate the addition and removal of significant features and information to the first dataset, which may be caused by privacy concerns and regulations.

In one example, the first model may be part of a video analytics engine that analyzes driving footage recorded by one or more cameras 105 and that outputs a series of tags describing semantic content of the footage. The video analytics engine may detect a collision with another vehicle, a near miss, a stop sign being neglected, distracted driving, and/or the like. The video analytics engine may include an ensemble of machine learning models, where each machine learning model is responsible for detecting one or more aspects of the aforementioned semantic content. Such models may be trained and fine-tuned on customer data. For example, an “object in hand” model may detect an interaction of a driver with objects (e.g., phone, food, a beverage, a cigarette, etc.). This model may be trained using large quantities of customer data, such as footage collected from customers and labeled.

In some implementations, the video system 110 may generate the first set of weights for the first model based on training the first model. For example, before training the first model, the video system 110 may preprocess the first dataset with operations, such as normalization, augmentation, and splitting the first dataset into a training subset and a validation subset. The preprocessing may ensure that the first dataset is in a suitable format for the first model to learn effectively. The video system 110 may initialize the first model (e.g., a deep learning model, such as a neural network) with random or pre-trained weights. This initialization provides the first model with a starting point from which the first model may learn during training.

The training of the first model may include forward propagation, loss calculation, and back propagation. The first model may process input data from the first dataset through layers of neurons during forward propagation. Each layer may apply a first set of weights and biases to the input data to produce a transformed output. Output of the first model may be compared to an expected output using a loss function (e.g., a mean squared error for regression tasks, cross-entropy loss for classification tasks, and/or the like). The loss may quantify a difference between the first model's prediction and the actual target values. The loss may be propagated backward through the network to update the first set of weights. This may include calculating a gradient of the loss with respect to each weight and adjusting the first set weights in a direction that reduces the loss. The process of forward propagation, loss calculation, and back propagation may be repeated for multiple epochs (e.g., with several iterations) over the first dataset to progressively refine the first set of weights.

During training, the video system 110 may periodically evaluate the first model's performance based on the validation subset of the data that was not used for training. This may aid in monitoring the first model's performance and preventing overfitting by ensuring that the first model generalizes well to unseen data. In some implementations, techniques, such as early stopping, may be utilized to halt training when the first model's performance on the validation set ceases to improve. Additionally, hyperparameters such as learning rate, batch size, and network architecture may be tuned to optimize the first model's performance. Upon completion of the training process, the first set of weights for the first model may be finalized. The first set of weights may represent learned parameters of the first model that best map input data to desired outputs based on the first dataset.

As shown in FIG. 1B, and by reference number 130, the video system 110 may receive a request to delete a portion of the first dataset. For example, the video system 110 may receive a request from a customer to delete video data (e.g., a portion of the first dataset) that includes personally identifiable information (PII) due to privacy regulations. Alternatively, or additionally, the video system 110 may periodically scan for particular types of data, e.g., PII of a customer or all data associated with a particular individual, using classifier models, object detection, or the like and may automatically generate a request for deletion of video data. The request may identify specific video data entries, associated with the customer, that need to be deleted. When the portion of the first dataset is subject to privacy regulations, the video system 110 may not utilize the portion of the first dataset to retrain the first model. An effect of privacy regulations is that, at any time, a customer can ask to delete all sensitive data, including video data. This means that the video system 110 must remove the customer's video data from the first dataset, and may not utilize the customer's video data to train the first model any longer. The deletion of such data may cause the first model, during subsequent re-training activities, to lose an ability to draw conclusions on data similar to the data being deleted.

In some implementations, the first dataset may be subject to one or more data removal policies, such a joint incremental policy, a data substitution policy, a subcategory decremental policy, or a subcategory incremental/decremental policy. Each of the policies may be characterized by a different advent of fresh data Sₖ and/or by different removal policies applied to the first dataset Dₖ. In the joint incremental policy, no data removal policy may be applied (i.e., Uₖ₋₁=Ø). Moreover, the first dataset may increase over time as new data is continuously added to the first dataset without any removal, resulting in an expanding dataset

$${D}_{k} = {⋃}_{i = 1}^{k - 1} {S}_{i} .$$

In a final step, the entire first dataset may be utilized in the training phase. In this scenario the subcategories in the first dataset do not change and hence Z₁=Z₂= . . . =Z_{K}. This policy is not privacy-preserving, as it assumes that data is never removed.

In the data substitution policy, the data sources Sₖ for k>1 may continuously add new data for each category to the first dataset, and a data removal policy π_{ds} may enforce removal of a subset of samples from all categories Uₖ₋₁ whose size is |Ski. This means that the number of available samples is constant over the different steps, namely |Dₖ|=|S₁|·∀k. The subcategories distribution Zₖ may remain constant across the steps and may not change over time. This scenario mimics real-world data collection in which a policy removes old data while new data is continuously added.

In the subcategory decremental policy, a data removal policy π_{d} acts to reduce the subcategories in the first dataset at every step, meaning that a new data source does not contain a subset of old subcategories and that samples belonging to the old subcategories are removed from the first dataset. This translates into Z₁⊃Z₂⊃ . . . ⊃Z_{K} and the subset of removed samples from the policy πd is:

$${U}_{k - 1} = \{ ( x , z , y ) ∈ {D}_{k - 1} \vert z ∈ {Z}_{k - 1} ∖ {Z}_{k} \} \qquad ( 3 )$$

This leads to a decrease in the number of subcategories over time, but not necessarily to a decrease in the number of samples in the first dataset since new samples from remaining subcategories are added. This scenario simulates a situation where data associated with shared characteristics, and represented by subcategories, may be removed. Meanwhile, new data may continue to be collected from data sources.

In the subcategory incremental/decremental policy, the first dataset may initially start with a subset of all available subcategories. Due to the removal policy π_{di}, some subcategories may be removed, at every step, while some other previously unseen subcategories may be added. More formally:

$${Z}_{k - 1} ∖ {Z}_{k} \neq ∅ , {Z}_{k} ∖ {Z}_{k - 1} \neq ∅ , {Z}_{k} ⋂ {⋃}_{i = 2}^{k - 1} ( {Z}_{i - 1} ∖ {Z}_{i} ) = ∅ \qquad ( 4 )$$

$${U}_{k - 1} = \{ ( x , y , z ) ∈ {D}_{k - 1} \vert z ∈ {Z}_{k - 1} ∖ {Z}_{k} \} \qquad ( 5 )$$

The constraints in Equation (4) may ensure that, at each training step, old subcategories are always removed, new subcategories are always added, and that removed subcategories are never added again, respectively. Additionally, the set of removed samples in Equation (5) may be defined as in the subcategory decremental policy, since all the samples that belong to the removed subcategories are eliminated. New samples Sₖ may not necessarily belong exclusively to the newly introduced subcategories Zₖ\Zₖ₋₁, but may belong to some previously seen subcategories. This may indicate that old data with shared characteristics are removed, and are never reintroduced in later time steps, while new data sources introduce samples with novel characteristics into the first dataset.

As further shown in FIG. 1B, and by reference number 135, the video system 110 may delete the portion of the first dataset based on the request and generate a modified first dataset. For example, upon receiving the request, the video system 110 may identify and remove the specified video data entries from the first dataset (e.g., the portion of the first dataset), thereby creating a modified first dataset that no longer includes the deleted entries (e.g., the portion). This may ensure compliance with privacy regulations while allowing the video system 110 to continue utilizing the remaining data for training and other purposes. Additionally, or alternatively, the video system 110 may remove the specified portion of the first dataset based on one of the data removal policies described above. For example, the video system 110 may not receive a request to delete the portion of the first dataset, but rather may delete the portion of the first dataset based on enforcing one of the data removal policies described above.

As shown in FIG. 1C, and by reference number 140, the video system 110 may receive a second dataset containing new data. For example, the cameras 105 may capture new video data, which may include updated driving footage, new traffic conditions, and/or other relevant data. The cameras 105 may provide the new video data to the data structure, and the data structure may store the new video data as the second dataset. In some implementations, the cameras 105 may periodically store the new video data in the data structure, may continuously store the new video data in the data structure, may store the new video data in the data structure based on a request, and/or the like. In some implementations, the new video data may include new road scenes captured by the cameras 105, new driving events associated with the vehicle, new driver and in-cabin events associated with a driver of the vehicle, and/or the like. The video system 110 may continuously receive the second dataset from the data structure, may periodically receive the second dataset from the data structure, may receive the second dataset from the data structure based on requesting the second dataset, and/or the like. In some implementations, the video system 110 may continuously (e.g., in near-real-time) receive the second dataset directly from the cameras 105, may periodically receive the second dataset from the cameras 105, and/or the like.

As further shown in FIG. 1C, and by reference number 145, the video system 110 may generate a second model with the first set of weights from the first model. For example, the video system 110 may initialize a second model (e.g., a deep learning model) using the first set of weights obtained from training the first model with the first dataset. This may ensure that the second model retains the knowledge acquired from the first model while being updated with new data from the second dataset. The video system 110 may further train or fine-tune the second model with the new data to improve an accuracy and a robustness of the second model in real-world applications, as described below. In some implementations, the second model may perform the same functions as the first model, but may be fine-tuned (e.g., retrained) based on the second dataset.

As shown in FIG. 1D, and by reference number 150, the video system 110 may fine-tune the second model with the second dataset and to generate a second set of weights for the second model. For example, the video system 110 may include an incremental learning model with a feature extraction backbone denoted as fₖ(⋅,θₖ), where θₖ denotes parameters updated across incremental steps, and a classifier with parameters Wₖ. An output of the second model (M) at time k may depend on both classifier weights Wₖ and feature extractor weights θₖ, as follows:

$$M ( x ; {θ}_{k} , {W}_{k} ) = p ( y \vert x ; {θ}_{k} , {W}_{k} ) , \qquad ( 6 )$$

where x∈Xₖ and y∈Yₖ. Fine-tuning with a cross entropy loss [symbol] to update the weights θₖ and Wₖ for a novel task may lead to forgetting, since parameters θₖ are adjusted to accommodate a new task. This baseline may be considered for incremental and decremental continual learning scenarios.

Regularization techniques may introduce an additional regularization loss [symbol] acting on model weights or activations, to mitigate catastrophic forgetting. A final training loss may be defined as:

$${ℒ}_{k} = {ℒ}_{k}^{c l s} + {λℒ}_{k}^{r e g} , \qquad ( 7 )$$

where [symbol] is a classification loss at time k, [symbol] is a regularization loss, and λ∈R is a hyper-parameter weighting the contributions of the losses. The regularization loss may include an elastic weight consolidation (EWC) loss. An EWC loss may mitigate forgetting by controlling weight drift. The EWC loss may employ a diagonal approximation of a Fisher information matrix, identifying the most important weights from previous tasks. The final weight regularization loss may be defined as:

$${ℒ}_{k}^{E W C} = {( {θ}_{k} - {θ}_{k - 1}^{*} )}^{T} diag ( {F}_{k - 1} ) ( {θ}_{k} - {θ}_{k - 1}^{*} ) , \qquad ( 8 )$$

where diag(Fₖ₋₁) is a diagonal empirical Fisher information matrix computed on a previous task and

$${θ}_{k - 1}^{*}$$

are feature extractor weights frozen after task k−1.

In some implementations, the video system 110 may generate the second set of weights for the second model based on fine-tuning the second model with the second dataset. For example, the video system 110 may preprocess the second dataset with operations, such as normalization, augmentation, and splitting the second dataset into a training subset and a validation subset. The preprocessing may ensure that the second dataset is in a suitable format for the second model to learn effectively. The video system 110 may initialize the second model with the first set of weights. This initialization provides the second model with a starting point from which the second model may learn during training. The second set of weights may represent learned parameters of the second model that best map input data to desired outputs based on the second dataset.

As shown in FIG. 1E, and by reference number 155, the video system 110 may utilize knowledge distillation to generate a knowledge distillation loss by comparing outputs of the first model and the second model based on the modified first dataset. For example, knowledge distillation is a technique that may be utilized in incremental learning to mitigate activation drift, by constraining an output of the second model based on current task data to be similar to an output of the second model based on previous task data. A knowledge distillation loss may be defined as:

$${ℒ}_{k}^{K D} = K L ( p ( y \vert x ; {θ}_{k - 1}^{*} , {W}_{k - 1} , τ ) ‖ p ( y \vert x ; {θ}_{K} , {W}_{k} , τ ) ) , \qquad ( 9 )$$

where KL denotes a Kullback-Leibler divergence between an output probability distribution of the second model trained after task k−1 and an output probability distribution of the first model on the same input x∈Xₖ, and r is a temperature parameter used to soften the output probabilities.

From a theoretical standpoint, a machine learning model can be defined as a set of weights θ. The values of the weights maybe used in a computation that produces a certain output given a certain input. An object of training a model is to determine an optimal set of weights θ*, which may be the set of weights that enables the model to achieve a desired behavior. The optimal set of weights may be obtained by minimizing a loss function [symbol] Loss functions may take different shapes and features. A particular loss function ( [symbol] ) may measure how far predictions on a training set of a model undergoing training are from expected outputs. As stated above, minimizing the loss function means determining a set of weights that allows the predictions to be as close as possible as a ground truth. Loss functions can include many different conditions. In knowledge distillation, given a trained first model θ*, the loss function's objective is to k−1 optimize the weights to output correct predictions, and to cause the second model to perform k as close as possible to the first model. Such a loss function may be defined as follows:

$${ℒ}_{k} = {ℒ}_{k}^{c l s} + {λℒ}_{k}^{r e g} , \qquad ( 10 )$$

where λ is a regularization parameter, controlling how much each of the addends will contribute to the final loss, and

$${ℒ}_{k}^{K D} = K L ( p ( y \vert x ; {θ}_{k - 1}^{*} ) ‖ p ( y \vert x ; {θ}_{K} ) ) , \qquad ( 11 )$$

is the Kullback-Leibler divergence between the output probability distribution of the first model

$$( {θ}_{k - 1}^{*} )$$

and the output probability distribution of the second model (θ_{K}) currently undergoing training on the same k input x∈X. In other words, adopting [symbol] translates to constraining the second model (called a student) to approximately behave like the first model (called a teacher), by producing approximately the same output given the same input.

Even if some data is removed from the first dataset due to privacy concerns, distilling from previous models (e.g., where such data was present, and therefore contributed to shape an output space) allows the knowledge about such data not to be lost forever, while at the same time new data samples contribute to define a new output space. With knowledge distillation, the video system 110 may mitigate a forgetting effect on the second model, and the second model may perform even better than the first based on fine tuning the second model on the new data of the second dataset.

As shown in FIG. 1F, and by reference number 160, the video system 110 may combine the knowledge distillation loss and a classification loss of the second model to generate a combined loss. For example, the video system 110 may utilize knowledge distillation to generate the knowledge distillation loss by comparing the outputs of the first model and the second model based on the modified first dataset. The classification loss may measure the differences between the predictions of the second model and the expected outputs of the second model. The video system 110 may then combine the knowledge distillation loss and the classification loss to generate a combined loss. This combined loss may be used when training the second model, and may ensure that the second model retains knowledge from the first model while also learning from the new data in the second dataset.

As shown in FIG. 1G, and by reference number 165, the video system 110 may train the second model with the combined loss and generate a trained second model. For example, the training of the second model may include forward propagation, loss calculation, and back propagation. The second model may process input data from the modified first dataset and the second dataset through layers of neurons during forward propagation. Each layer may apply a second set of weights and biases to the input data to produce a transformed output. Output of the second model may be compared to an expected output using a loss function (e.g., the combined loss). The combined loss may quantify a difference between the second model's prediction and the actual target values. The combined loss may be propagated backward through the network to update the second set of weights. This may include calculating a gradient of the combined loss with respect to each weight and adjusting the second set weights in a direction that reduces the combined loss. The process of forward propagation, loss calculation, and back propagation may be repeated for multiple epochs (e.g., with several iterations) over the modified first dataset and the second dataset to progressively refine the second set of weights.

During training, the video system 110 may periodically evaluate the second model's performance based on the validation subset of the data that was not used for training. This may aide in monitoring the second model's performance and preventing overfitting by ensuring that the second model generalizes well to unseen data. In some implementations, techniques, such as early stopping, may be utilized to halt training when the second model's performance on the validation set ceases to improve. Additionally, hyperparameters such as learning rate, batch size, and network architecture may be tuned to optimize the second model's performance. Upon completion of the training process, the second set of weights for the trained second model may be finalized. The second set of weights may represent learned parameters of the trained second model that best map input data to desired outputs based on the modified first dataset and the second dataset.

In some implementations, the process described above in connection with FIGS. 1A-1G may be performed every time data is removed from the first dataset, data is removed from the second dataset, new data from a third dataset is added, and/or the like. In such implementations, the video system 110 may generate a trained third model with a third set of weights, and may perform additional actions based on the trained third model and the third set of weights.

As shown in FIG. 1H, and by reference number 170, the video system 110 may perform one or more actions based on the trained second model and the second set of weights. For example, performing the one or more actions may include the video system 110 implementing the trained second model and the second set of weights in a camera associated with a vehicle. The video system 110 may store the trained second model and the second set of weights in the camera 105 of the vehicle so that the camera 105 may accurately calculate distances to objects encountered by the vehicle in real time. This may enable the vehicle and/or a driver of the vehicle to operate the vehicle more safely. In this way, the video system 110 conserves computing resources, networking resources, and/or other resources that would have otherwise been consumed by handling legal actions associated with vehicle accidents.

In some implementations, performing the one or more actions may include the video system 110 implementing the trained second model and the second set of weights in a vehicle. For example, the video system 110 may store the trained second model and the second set of weights in the vehicle so that the vehicle may accurately calculate distances to objects encountered by the vehicle in real time. This may enable the vehicle and/or a driver of the vehicle to operate the vehicle more safely. In this way, the video system 110 conserves computing resources, networking resources, and/or other resources that would have otherwise been consumed by deploying emergency services for handling vehicle accidents.

In some implementations, performing the one or more actions may include the video system 110 utilizing the trained second model and the second set of weights to provide an alert to a vehicle. For example, the video system 110 may receive video data from the camera 105 in real time, and may utilize the trained second model and the second set of weights to determine that the vehicle is within an unsafe distance from an object. The video system 110 may generate an alert indicating the unsafe distance, and may provide the alert to the vehicle. The vehicle may provide the alert (e.g., a visual alert, an audible alert, and/or the like) to a driver of the vehicle. In this way, the video system 110 conserves computing resources, networking resources, and/or other resources that would have otherwise been consumed by handling traffic violations and/or accidents caused by poor operation of the vehicle by the driver.

In some implementations, performing the one or more actions may include the video system 110 utilizing the trained second model and the second set of weights to provide an alert to a fleet manager of a vehicle. For example, the video system 110 may receive video data from the camera 105 in real time, and may utilize the trained second model and the second set of weights to determine that the vehicle is performing an unsafe maneuver (e.g., tailgating). The video system 110 may generate an alert indicating the unsafe maneuver, and may provide the alert to the fleet manager of the vehicle. The fleet manager may take appropriate action against the driver of the vehicle based on the alert. In this way, the video system 110 conserves computing resources, networking resources, and/or other resources that would have otherwise been consumed by handling complaints for a driver of a vehicle associated with a fleet of vehicles.

In some implementations, performing the one or more actions may include the video system 110 utilizing the trained second model and the second set of weights to schedule a driver of a vehicle for training. For example, the video system 110 may receive video data from the camera 105 in real time, and may utilize the trained second model and the second set of weights to determine that the vehicle is performing an unsafe maneuver (e.g., tailgating). The video system 110 may schedule the driver of the vehicle for training associated with safe driving tactics so that the driver learns to not tailgate. In this way, the video system 110 conserves computing resources, networking resources, and/or other resources that would have otherwise been consumed by handling lawsuits associated with unsafe driving by a driver of a vehicle associated with a fleet of vehicles.

In this way, the video system 110 provides privacy preservation when training deep learning models. For example, the video system 110 may preserve an accuracy and a robustness of a model after data deletions necessitated by privacy regulations. The video system 110 may utilize knowledge to retain and transfer knowledge from previous model iterations to new models, and may minimize degradation of model performance due to removal of training data. The video system 110 prevent catastrophic forgetting by a model based on implementing measures that ensure a stability of a learned representation over successive learning cycles. The video system 110 may also prevent wasteful retraining of models from scratch. Thus, the video system 110 may conserve computing resources, networking resources, and/or other resources that would have otherwise been consumed by failing to handle deletion of data for training a model, failing to train a model with new data that includes changing characteristics, degrading performance of a model based on deleting data used to train the model, failing to employ incremental learning techniques for a model, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

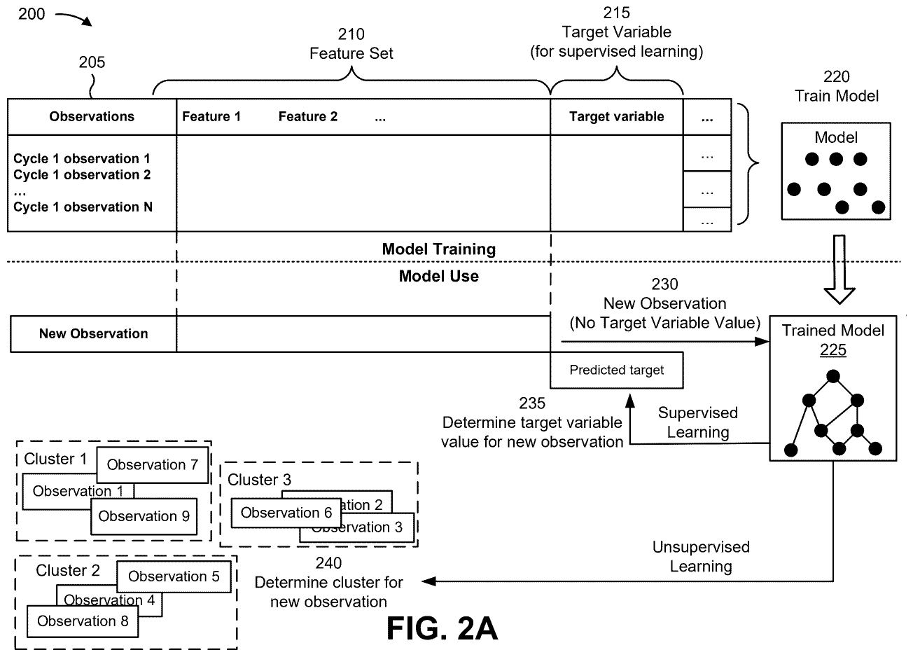

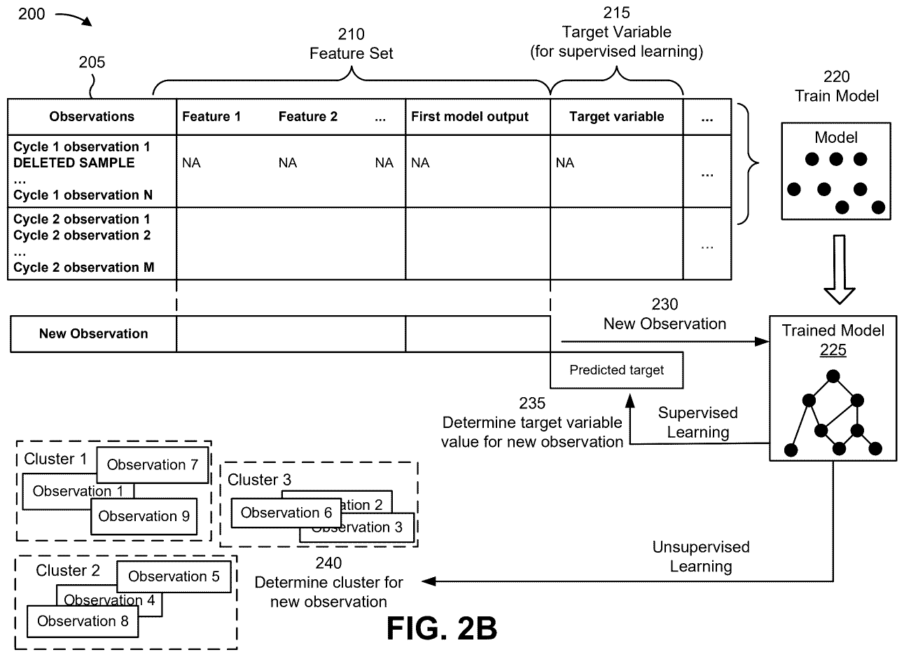

FIGS. 2A and 2B are diagrams illustrating examples 200 of training and using machine learning models. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature, a second feature, a third feature, and so on. As shown in FIG. 2A, for a learning cycle 1 observation 1, the first feature may have a value of feature 1, the second feature may have a value of feature 2, and so on. These features and feature values are provided as examples and may differ in other examples. A first machine learning model may be trained using the learning cycle 1 observations.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a first trained machine learning model 225 to be used to analyze new observations.

As shown by reference number 230, the machine learning system may apply the first trained machine learning model 225 to a new observation, such as by receiving a new observation and inputting the new observation to the first trained machine learning model 225. The machine learning system may apply the first trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster, then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster, then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

As shown in FIG. 2B, the machine learning system may train a second machine learning model using learning cycle 2 observations and learning cycle 1 observations that are not deleted after learning cycle 1. For example, as shown in FIG. 2B, learning cycle 1 observation 2 may deleted from the learning cycle 1 observations, and may not be utilized when training the second machine learning model. The machine learning system may also utilize outputs from the trained first machine learning model to train the second machine learning model. For example, the machine learning system may utilize the outputs from the trained first machine learning model to evaluate knowledge distillation loss associated with the second machine learning model.

In this way, the machine learning system may apply a rigorous and automated process to continuously train a machine learning model. The machine learning system enables recognition and/or identification of tens, hundreds, thousands, or millions of features and/or feature values for tens, hundreds, thousands, or millions of observations, thereby increasing accuracy and consistency and reducing delay associated with continuously training a machine learning model relative to requiring computing resources to be allocated for tens, hundreds, or thousands of operators to manually train a machine learning model.

As indicated above, FIGS. 2A and 2B are provided as an example. Other examples may differ from what is described in connection with FIGS. 2A and 2B.

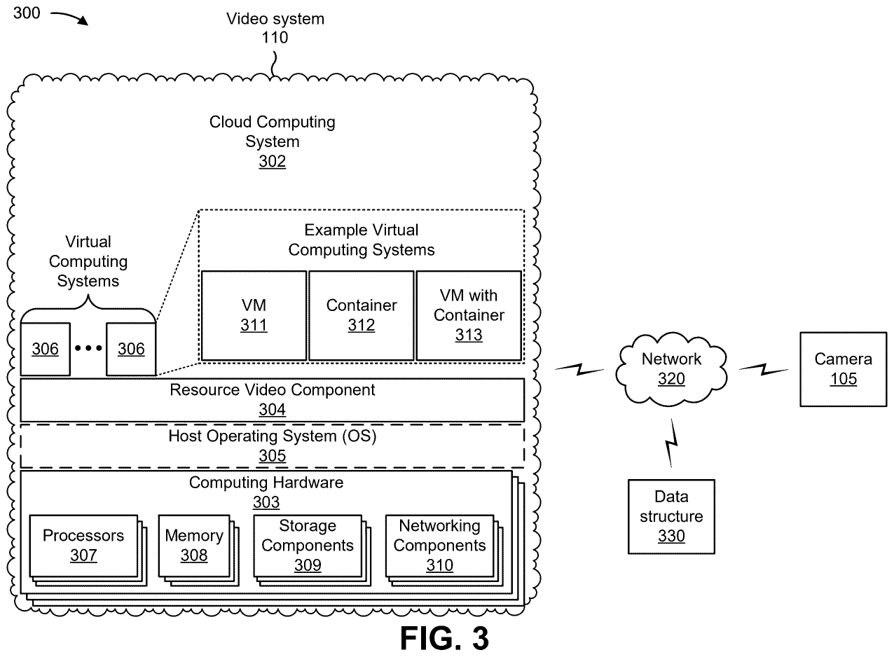

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include a camera 105, a network 320, and/or a data structure 330. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a dashcam of a vehicle, a forward-facing camera of a vehicle, a driver-facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

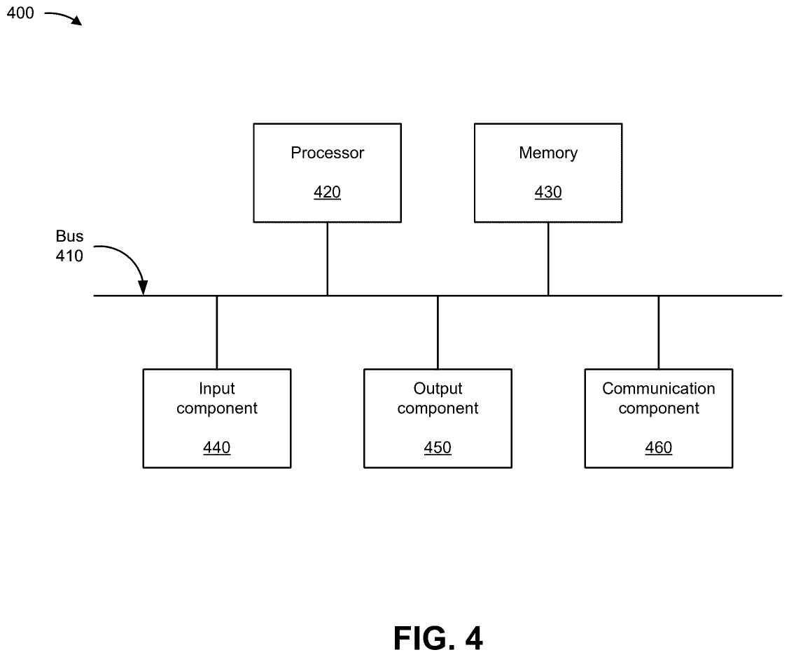

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the camera 105, the video system 110, and/or the data structure 330. In some implementations, the camera 105, the video system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

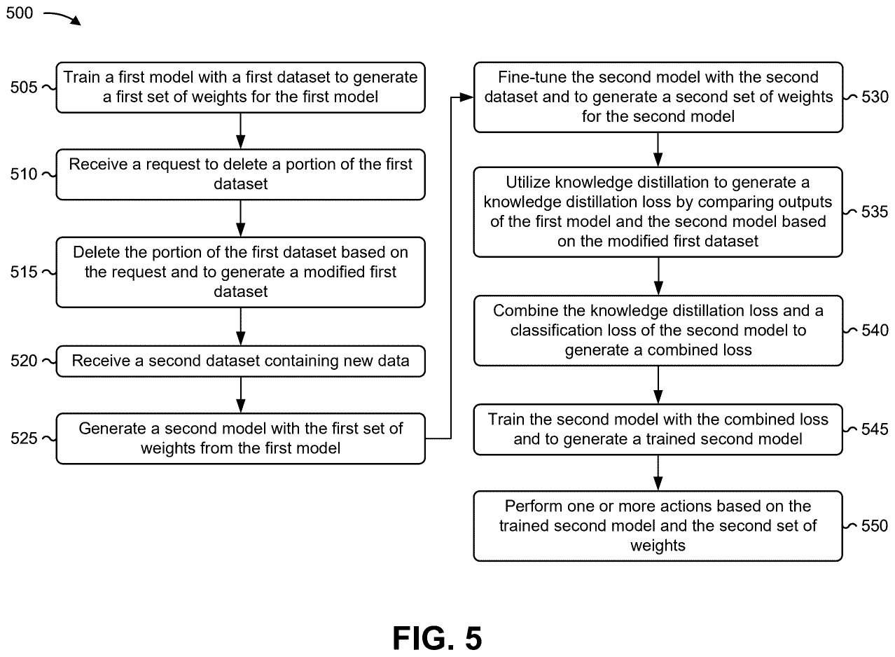

FIG. 5 depicts a flowchart of an example process 500 for providing privacy preservation when training deep learning models. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., the camera 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include training a first model with a first dataset to generate a first set of weights for the first model (block 505). For example, the device may train a first model with a first dataset to generate a first set of weights for the first model, as described above.

As further shown in FIG. 5, process 500 may include receiving a request to delete a portion of the first dataset (block 510). For example, the device may receive a request to delete a portion of the first dataset, as described above.

As further shown in FIG. 5, process 500 may include deleting the portion of the first dataset based on the request and to generate a modified first dataset (block 515). For example, the device may delete the portion of the first dataset based on the request and to generate a modified first dataset, as described above. In some implementations, the portion of the first dataset is deleted to comply with privacy regulations.

As further shown in FIG. 5, process 500 may include receiving a second dataset containing new data (block 520). For example, the device may receive a second dataset containing new data, as described above. In some implementations, the second dataset includes video data associated with driving footage of a vehicle.

As further shown in FIG. 5, process 500 may include generating a second model with the first set of weights from the first model (block 525). For example, the device may generate a second model with the first set of weights from the first model, as described above. In some implementations, each of the first model and the second model is a deep learning model.

As further shown in FIG. 5, process 500 may include fine-tuning the second model with the second dataset and to generate a second set of weights for the second model (block 530). For example, the device may fine-tune the second model with the second dataset and to generate a second set of weights for the second model, as described above.

As further shown in FIG. 5, process 500 may include utilizing knowledge distillation to generate a knowledge distillation loss by comparing outputs of the first model and the second model based on the modified first dataset (block 535). For example, the device may utilize knowledge distillation to generate a knowledge distillation loss by comparing outputs of the first model and the second model based on the modified first dataset, as described above. In some implementations, the knowledge distillation loss is calculated based on a Kullback-Leibler divergence between an output probability distribution of the first model and an output probability distribution of the second model.

As further shown in FIG. 5, process 500 may include combining the knowledge distillation loss and a classification loss of the second model to generate a combined loss (block 540). For example, the device may combine the knowledge distillation loss and a classification loss of the second model to generate a combined loss, as described above. In some implementations, the classification loss measures differences between predictions of the second model and expected outputs of the second model.

As further shown in FIG. 5, process 500 may include training the second model with the combined loss and to generate a trained second model (block 545). For example, the device may train the second model with the combined loss and to generate a trained second model, as described above. In some implementations, the training of the second model is performed iteratively at defined time intervals.

As further shown in FIG. 5, process 500 may include performing one or more actions based on the trained second model and the second set of weights (block 550). For example, the device may perform one or more actions based on the trained second model and the second set of weights, as described above. In some implementations, performing the one or more actions includes one or more of implementing the trained second model and the second set of weights in a camera associated with a vehicle, implementing the trained second model and the second set of weights in a vehicle, utilizing the trained second model and the second set of weights to provide an alert to a vehicle, utilizing the trained second model and the second set of weights to provide an alert to a fleet manager of a vehicle, or utilizing the trained second model and the second set of weights to schedule a driver of a vehicle for training.

In some implementations, process 500 includes receiving an instruction to delete data samples from the second dataset due to privacy regulations, and deleting the data samples from the second dataset based on the instruction. In some implementations, process 500 includes determining a performance of the second model based on a test dataset, and evaluating retention of knowledge and adaptation to the test dataset based on the performance. In some implementations, process 500 includes applying a removal policy to the second dataset to simulate the portion of the first dataset that is deleted.

In some implementations, process 500 includes receiving another request to delete a portion of the second dataset, deleting the portion of the second dataset based on the other request and to generate a modified second dataset, receiving a third dataset containing additional new data, generating a third model with the second set of weights from the second model, fine-tuning the third model with the third dataset and to generate a third set of weights for the third model, utilizing knowledge distillation to generate another knowledge distillation loss by comparing outputs of the second model and the third model based on the modified second dataset, combining the other knowledge distillation loss and another classification loss of the third model to generate another combined loss, and training the third model with the combined loss and to generate a trained third model. In some implementations, process 500 includes performing one or more additional actions based on the trained third model and the third set of weights.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
training, by a device, a first model with a first dataset to generate a first set of weights for the first model;
receiving, by the device, a request to delete a portion of the first dataset;
deleting, by the device, the portion of the first dataset based on the request and to generate a modified first dataset;
receiving, by the device, a second dataset containing new data;
generating, by the device, a second model with the first set of weights from the first model;
fine-tuning, by the device, the second model with the second dataset and to generate a second set of weights for the second model;
utilizing, by the device, knowledge distillation to generate a knowledge distillation loss by comparing outputs of the first model and the second model based on the modified first dataset;
combining, by the device, the knowledge distillation loss and a classification loss of the second model to generate a combined loss;
training, by the device, the second model with the combined loss and to generate a trained second model; and
performing, by the device, one or more actions based on the trained second model and the second set of weights.

2. The method of claim 1, wherein performing the one or more actions comprises one or more of:
implementing the trained second model and the second set of weights in a camera associated with a vehicle;
implementing the trained second model and the second set of weights in a vehicle;
utilizing the trained second model and the second set of weights to provide an alert to a vehicle;
utilizing the trained second model and the second set of weights to provide an alert to a fleet manager of a vehicle; or
utilizing the trained second model and the second set of weights to schedule a driver of a vehicle for training.

3. The method of claim 1, further comprising:
receiving an instruction to delete data samples from the second dataset due to privacy regulations; and
deleting the data samples from the second dataset based on the instruction.

4. The method of claim 1, wherein the knowledge distillation loss is calculated based on a Kullback-Leibler divergence between an output probability distribution of the first model and an output probability distribution of the second model.

5. The method of claim 1, wherein the classification loss measures differences between predictions of the second model and expected outputs of the second model.

6. The method of claim 1, further comprising:
determining a performance of the second model based on a test dataset; and
evaluating retention of knowledge and adaptation to the test dataset based on the performance.

7. The method of claim 1, wherein the second dataset includes video data associated with driving footage of a vehicle.

8. A device, comprising:
one or more processors configured to:
train a first model with a first dataset to generate a first set of weights for the first model;
receive a request to delete a portion of the first dataset;
delete the portion of the first dataset based on the request and to generate a modified first dataset;
receive a second dataset containing new data;
generate a second model with the first set of weights from the first model;
fine-tune the second model with the second dataset and to generate a second set of weights for the second model;
utilize knowledge distillation to generate a knowledge distillation loss by comparing outputs of the first model and the second model based on the modified first dataset;
combine the knowledge distillation loss and a classification loss of the second model to generate a combined loss,
wherein the classification loss measures differences between predictions of the second model and expected outputs of the second model;
train the second model with the combined loss and to generate a trained second model; and
perform one or more actions based on the trained second model and the second set of weights.

9. The device of claim 8, wherein the one or more processors are further configured to:
apply a removal policy to the second dataset to simulate the portion of the first dataset that is deleted.

10. The device of claim 8, wherein the training of the second model is performed iteratively at defined time intervals.

11. The device of claim 8, wherein each of the first model and the second model is a deep learning model.

12. The device of claim 8, wherein the portion of the first dataset is deleted to comply with privacy regulations.

13. The device of claim 8, wherein the one or more processors are further configured to:
receive another request to delete a portion of the second dataset;
delete the portion of the second dataset based on the other request and to generate a modified second dataset;
receive a third dataset containing additional new data;
generate a third model with the second set of weights from the second model;
fine-tune the third model with the third dataset and to generate a third set of weights for the third model;
utilize knowledge distillation to generate another knowledge distillation loss by comparing outputs of the second model and the third model based on the modified second dataset;
combine the other knowledge distillation loss and another classification loss of the third model to generate another combined loss; and
train the third model with the combined loss and to generate a trained third model.

14. The device of claim 13, wherein the one or more processors are further configured to:
perform one or more additional actions based on the trained third model and the third set of weights.

15. A non-transitory computer-readable medium storing a set of instructions, the set of instructions comprising:
one or more instructions that, when executed by one or more processors of a device, cause the device to:
train a first model with a first dataset to generate a first set of weights for the first model;
receive a request to delete a portion of the first dataset;
delete the portion of the first dataset based on the request and to generate a modified first dataset,
wherein the portion of the first dataset is deleted to comply with privacy regulations;
receive a second dataset containing new data;
generate a second model with the first set of weights from the first model;
fine-tune the second model with the second dataset and to generate a second set of weights for the second model;
utilize knowledge distillation to generate a knowledge distillation loss by comparing outputs of the first model and the second model based on the modified first dataset;
combine the knowledge distillation loss and a classification loss of the second model to generate a combined loss;
train the second model with the combined loss and to generate a trained second model; and
perform one or more actions based on the trained second model and the second set of weights.

16. The non-transitory computer-readable medium of claim 15, wherein the one or more instructions, that cause the device to perform the one or more actions, cause the device to one or more of:
implement the trained second model and the second set of weights in a camera associated with a vehicle;
implement the trained second model and the second set of weights in a vehicle;
utilize the trained second model and the second set of weights to provide an alert to a vehicle;
utilize the trained second model and the second set of weights to provide an alert to a fleet manager of a vehicle; or
utilize the trained second model and the second set of weights to schedule a driver of a vehicle for training.

17. The non-transitory computer-readable medium of claim 15, wherein the knowledge distillation loss is calculated based on a Kullback-Leibler divergence between an output probability distribution of the first model and an output probability distribution of the second model.

18. The non-transitory computer-readable medium of claim 15, wherein the one or more instructions further cause the device to:
determine a performance of the second model based on a test dataset; and
evaluate retention of knowledge and adaptation to the test dataset based on the performance.

19. The non-transitory computer-readable medium of claim 15, wherein the one or more instructions further cause the device to:
apply a removal policy to the second dataset to simulate the portion of the first dataset that is deleted.

20. The non-transitory computer-readable medium of claim 15, wherein the training of the second model is performed iteratively at defined time intervals.
